(19) United States
(12) Patent Application Publication
(10) Pub. No.: US 2011/0034197 A1
(43) Pub. Date: Feb. 10, 2011

(54) APPARATUS AND METHOD FOR SIGNALLING ACTIVE ASSIGNMENTS TO A GROUP OF WIRELESS STATIONS

(76) Inventor: Robert Novak, Ottawa (CA)

Correspondence Address: SMART & BIGGAR, 438 UNIVERSITY AVENUE, SUITE 1500, BOX 111, TORONTO, ON, M5G 2K8, CA

(21) Appl. No.: 12/830,797

(22) Filed: Jul. 6, 2010

Related U.S. Application Data
(60) Provisional application No. 12/589,548, filed on Jul. 3, 2009.

(51) Int. Cl. H04W 72/02

(52) U.S. Cl. 455/509

(57) ABSTRACT

In a method of signalling active assignments to an ordered group of wireless terminals in communication with a base station in a wireless communication system, each wireless terminal of the ordered group having a corresponding position within the ordered group, the base station: determines an allocation of active assignments for the ordered group, the allocation corresponding to a number of active assignments; determines an index value identifying the allocation in a set of possible allocations for the number of active assignments for the ordered group; and transmits the index value to at least one wireless terminal of the ordered group of wireless terminals

### RELATED APPLICATIONS

This application claims the benefit of U.S. Provisional Patent Application No. 61/222,947, filed in the United States Patent Office on Jul. 3, 2009, the contents of which are incorporated by reference herein.

This application is a continuation-in-part of the non-provisional application (serial number tbd) resulting from conversion under 37 C.F.R. §1.53(c)(3) of U.S. provisional patent application No. 61/222,947 filed on Jul. 3, 2009, which claims the benefit of U.S. provisional patent application No. 61/078,525 filed on Jul. 7, 2008.

### FIELD OF THE INVENTION

The present invention relates to wireless communication systems. More particularly, the present invention relates to apparatus and method for signalling active assignments to a group of wireless stations in a wireless communication system.

### BACKGROUND

Wireless communication systems are widely deployed to provide various types of communication content such as voice, data, and other content. These systems may be multiple-access systems capable of simultaneously supporting communication for multiple wireless terminals by sharing the available transmission resources (e.g., frequency channel and/or time interval). Since the transmission resources are shared, efficient allocation of the transmission resources is important as it impacts the utilization of the transmission resources and the quality of service perceived by individual terminal users. One such wireless communications system is the Orthogonal Frequency-Division Multiple Access (OFDMA) system in which multiple wireless terminals perform multiple-access using Orthogonal Frequency-Division Multiplexing (OFDM).

OFDM is a multi-carrier modulation technique that partitions the overall system bandwidth into multiple orthogonal frequency channels, each of which is associated with a respective subcarrier that may be modulated with data. In OFDMA, the transmission resource extends over two dimensions: frequency channels and time intervals. The resources of a given frequency channel may involve contiguous and/or non-contiguous groups of subcarriers.

Examples of OFDM communication systems include, but are not limited to, wireless protocols such as the wireless local area network (“WLAN”) protocol defined according to the Institute of Electrical and Electronics Engineering (“IEEE”) standards radio 802.11a, b, g, and n (hereinafter “Wi-Fi”), the Wireless MAN/Fixed broadband wireless access (“BWA”) standard defined according to IEEE 802.16 (hereinafter “WiMAX”), the mobile broadband 3GPP Long Term Evolution (“LTE”) protocol having air interface High Speed OFDM Packet Access (“HSOPA”) or Evolved UMTS Terrestrial Radio Access (“E-UTRA”), the 3GPP2 Ultra Mobile Broadband (“UMB”) protocol, digital radio systems Digital Audio Broadcasting (“DAB”) protocol, Hybrid Digital (“HD”) Radio, the terrestrial digital TV system Digital Video Broadcasting-Terrestrial (“DVB-T”), the cellular communication systems Flash-OFDM, etc. Wired protocols using OFDM techniques include Asymmetric Digital Subscriber Line (“ADSL”) and Very High Bitrate Digital Subscriber Line (“VDSL”) broadband access, Power line communication (“PLC”) including Broadband over Power Lines (“BPL”), and Multimedia over Coax Alliance (“MoCA”) home networking.

There are several proposals to 3GPP2 for OFDMA VoIP implementations, one of which defines numerology such that an OFDMA resource consisting of a set of 340 subcarriers in frequency over OFDM symbol durations in time is divided into 20 ms VoIP frames, each containing 24 slots, each slot containing 10 OFDM symbols. The resources of each slot are further subdivided into distributed resource channels (DRCH), each comprising 81 subcarrier locations distributed across the 10 symbols of a slot for a total of 40 DRCHs per slot allowing for pilots and other overhead that might be present. Transmission for a given user occurs at different rates or frame sizes. For example, the EVRC (Enhanced Variable Rate Codec) codec generates voice frames with four different rates or frame sizes: full, ½, ¼ and ⅛ with probabilities of 29%, 4%, 7% and 60% respectively. The particular rate is typically determined as a function of a voice activity factor. For a given user, a single packet is nominally expected to be delivered within one VoIP frame. Current definitions allow for an initial attempt to deliver the packet and three subsequent attempts. Any attempt, including the initial or subsequent, is referred to herein as a subpacket.

Generally, there are a large number of terminals that can access a multiple-access system at any time. Each of these terminals needs to be scheduled and allocated transmission resources. Scheduling involves allocating the transmission resources to particular terminals, and performing any signalling necessary for terminals to know when and where their resources are being scheduled.

The allocation of transmission resources to groups of wireless terminals is typically controlled by the base station through conventional bitmap signalling. In an exemplary conventional bitmap signalling scheme, terminals are grouped into groups according to a predefined metric—for example, terminals with roughly the same arrival time, and/or similar channel conditions, and/or same or similar MCS (modulation and coding scheme) levels, may be grouped and identified by a Group ID. Wireless terminals may join and leave groups, typically under the control of the base station. A terminal may leave a group, for example, if a VoIP call on the terminal has ended, or if the terminal no longer satisfies the requirements to be within the group according to the predefined metric (e.g., it leaves the cell). A terminal may join a group, for example, if it has started a VoIP call (or has one in progress) and it satisfies the predefined metric.

During a scheduling interval, a respective Ordered Assignments Bitmap (OAB) is sent for each group, where each wireless terminal in a group is associated with a respective bit position of the corresponding OAB. The OAB is used to indicate which terminal(s) in the group is/are active. A terminal is active, (i.e. assigned resources), if its corresponding bit is set to “1”. A terminal is inactive (i.e. not assigned resources) if its corresponding bit is set to “0”. Other parameters, such as a Resource Allocation Bitmap (RAB), may additionally be used to indicate the amount of transmission resources being allocated to each active terminal.

A scheduling interval may be any period that has been assigned for a particular task (e.g., transmission of control information and/or user data bursts). For example, in a VoIP implementation a scheduling interval may be used by all users in the VoIP group, and it could contain both control information (e.g. the OAB, etc) and the associated VoIP packet(s). Alternatively, the scheduling intervals for control information and associated VoIP packet(s) could be separate—e.g. the OAB could be in a different scheduling interval to the interval (patch) scheduled for user VoIP packet(s). From the OAB, the indicated VoIP users would know there is/are packet(s) for them to decode. Each VoIP user checks the scheduling interval associated with the OAB, and if it has a “1” in its assigned position the terminal decodes the relevant VoIP packet in the data burst associated with the scheduling interval for its Group ID.

In many cases scheduling also involves reserving future capacity to perform re-transmissions that may, for example, occur according to a conventional transmission error-control scheme such as Hybrid Automatic Repeat reQuest (HARQ).

A few variations of HARQ schemes exist. One variation is unicast HARQ in which each encoded packet includes data from one user. This can be fully asynchronous in which case the modulation and code rate (MCS—modulation and coding scheme), transmission time (slot/frame) and resource allocation are independent for each transmission of an encoded packet (first and all re-transmissions). Assignment signalling is used to describe the resource allocation, MCS and user IDs for each transmission and re-transmission. While this approach allows adaptation to real time channel conditions, it incurs large signalling overhead. Unicast HARQ can alternatively be fully synchronous. In this case, the MCS scheme for transmissions (first and all retransmissions) is the same, resource allocation (location) remains the same for first and all retransmissions (the transmission location must be the same as the first transmission). The transmission interval is fixed, and assignment signalling is required only for the first transmission. This enables lower signalling overhead for retransmission, but can cause significant scheduling complexity and signalling overhead for the first transmission due to the irregular vacancies of resources that occurs since some resources need to be reserved for retransmissions that may not be necessary.

Another HARQ variant is multicast HARQ in which each encoded packet includes data for multiple users. The worst CQIs (channel quality indicators) among multiple users are considered for selecting MCS. The entire packet is retransmitted if one or more users could not decode it successfully, even though some of the users may have successfully decoded the packet. Multicast HARQ can be implemented using fully asynchronous and fully synchronous schemes.

With a large number of terminals, a large amount of transmission resources need to be dedicated for control signalling relating to scheduling, particularly in allocation schemes where every transmission and/or re-transmission of a packet needs to be scheduled.

Accordingly, there remains a need for new signalling schemes for resource allocation in a wireless communication system.

### SUMMARY OF THE INVENTION

In overview, a method of signalling active assignments to an ordered group of wireless terminals in communication with a base station in a wireless communication system, each wireless terminal of the ordered group having a corresponding position within the ordered group, comprises: at the base station: determining an allocation of active assignments for the ordered group, the allocation corresponding to a number of active assignments; determining an index value identifying the allocation in a set of possible allocations for the number of active assignments for the ordered group; and transmitting the index value to at least one wireless terminal of the ordered group of wireless terminals.

In some embodiments, the method further comprises transmitting an indication of the size of the ordered group to the at least one wireless terminal.

In some embodiments, the method further comprises transmitting to each of the at least one wireless terminal an indication of its corresponding position within the ordered group.

In some embodiments, the method further comprises: assigning each wireless terminal in the ordered group a position within a bitmap, the position within the bitmap corresponding to the position within the ordered group, wherein a bit set to “1” in the bitmap indicates an active assignment and a bit set to “0” in the bitmap indicates an inactive assignment, such that the bitmap indicates the allocation; creating a table associating an index with a corresponding set of values for the bitmap, the set of values corresponding to the set of possible allocations of the number of active assignments for the ordered group; and wherein the determining the index value comprises using the table to identify the index value in the index using the bitmap.

In some embodiments, the active assignments indicate which of the wireless terminals have been allocated transmission resources, and wherein the method further comprises allocating a number of transmission resource units to each of the active assignments.

In some embodiments, the active assignments indicate which of the wireless terminals have been allocated resources for re-transmission of a packet, and wherein the method further comprises allocating a number of transmission resource units to each of the active assignments. The re-transmission may be a HARQ re-transmission.

In some embodiments, the method further comprises transmitting an indication of the number of active assignments to the at least one wireless terminal.

In some embodiments, the method further comprises transmitting an indication of a number of active resource units (A) and a number of resource units per active assignment (U) to the at least one wireless terminal.

In a further aspect of the present application, a base station forming part of a communication system, the base station in communication with an ordered group of wireless terminals, each wireless terminal of the ordered group having a corresponding position within the ordered group, comprises logic operable to: determine an allocation of active assignments for the ordered group, the allocation corresponding to a number of active assignments; determine an index value identifying the allocation in a set of possible allocations for the number of active assignments for the ordered group; and transmit the index value to at least one wireless terminal of the ordered group of wireless terminals.

In some embodiments, the logic is further operable to transmit an indication of the size of the ordered group to the at least one terminal.

In some embodiments, the logic is further operable transmit to each of the at least one wireless terminal an indication of its corresponding position within the ordered group.

In some embodiments, the logic is further operable to: assign each wireless terminal in the ordered group a position within a bitmap, the position within the bitmap corresponding to the position within the ordered group, wherein a bit set to “1” in the bitmap indicates an active assignment and a bit set to “0” in the bitmap indicates an inactive assignment, such that the bitmap indicates the allocation; create a table associating an index with a corresponding set of values for the bitmap, the set of values corresponding to the set of possible allocations of the number of active assignments for the ordered group; and wherein the determining the index value comprises using the table to identify the index value in the index using the bitmap.

In some embodiments, the active assignments indicate which of the wireless terminals have been allocated transmission resources, and wherein the logic is further operable to allocate a number of transmission resource units to each of the active assignments.

In some embodiments, the active assignments indicate which of the wireless terminals have been allocated resources for re-transmission of a packet, and wherein the logic is further operable to allocate a number of transmission resource units to each of the active assignments. In some embodiments, the re-transmission may be a HARQ re-transmission.

In some embodiments, the logic is further operable to transmit an indication of the number of active assignments to the at least one wireless terminal.

In some embodiments, the logic is further operable to transmit an indication of a number of active resource units and a number of resource units per active assignment to the at least one wireless terminal.

In a further aspect of the present application, a wireless terminal comprises logic operable to: receive from a base station an indication that the wireless terminal has been added to an ordered group of wireless terminals; receive from the base station a terminal assignment index (TAI); and use the TAI to derive an ordered assignment bitmap (OAB), where each wireless terminal in the ordered group is associated with a respective bit position of the OAB.

In some embodiments, the logic is further operable to receive from the base station an indication of the size of the ordered group.

In some embodiments, the logic is further operable to determine a number of active assignments for the ordered group.

In some embodiments, using the TAI to derive the OAB comprises:

building a TAI table given the size of the ordered group and the number of active assignments for the ordered group; and using the TAI to lookup the OAB in the TAI table.

In some embodiments, determining the number of active assignments comprises receiving from the base station an indication of the number of active assignments.

In some embodiments, determining the number of active assignments comprises: receiving from the base station an indication of a number of assigned resource units for the ordered group; receiving from the base station an indication of a number of resource units per active assignment; and dividing the number of assigned resource units by the number of resource units per active assignment.

In some embodiments, the logic is further operable to receive from the base station an indication of a location for the wireless terminal within the ordered group.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate embodiments of the invention by example only,

FIG. 1 is a block diagram of a cellular communication system;

FIG. 2 is a block diagram of an example base station that might be used to implement some embodiments of the present application;

FIG. 3 is a block diagram of an example wireless terminal that might be used to implement some embodiments of the present application;

FIG. 4 is a block diagram of an example relay station that might be used to implement some embodiments of the present application;

FIG. 5 is a block diagram of a logical breakdown of an example OFDM transmitter architecture that might be used to implement some embodiments of the present application;

FIG. 6 is a block diagram of a logical breakdown of an example OFDM receiver architecture that might be used to implement some embodiments of the present application; and

FIG. 7 is a terminal assignment index table for a group of four wireless terminals with two active assignments.

### DETAILED DESCRIPTION

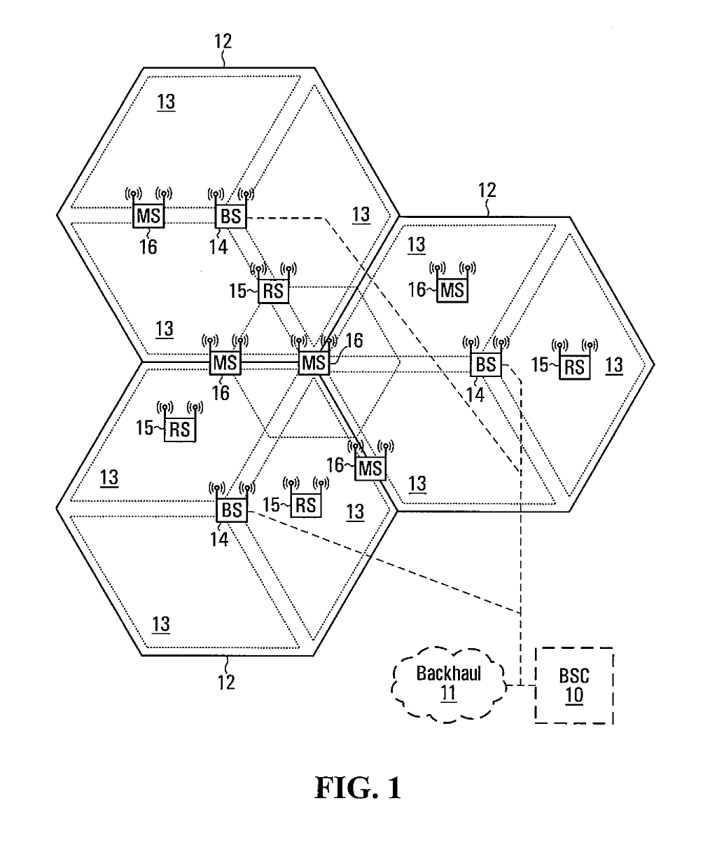

Referring to the drawings, FIG. 1 shows a base station controller (BSC) 10 which controls wireless communications within multiple cells 12, which cells are served by corresponding base stations (BS) 14. In some configurations, each cell is further divided into multiple sectors 13 or zones (not shown). In general, each base station 14 facilitates communications using OFDM with wireless terminals 16, which are within the cell 12 associated with the corresponding base station 14. The movement of the wireless terminals 16 in relation to the base stations 14 results in significant fluctuation in channel conditions. As illustrated, the base stations 14 and wireless terminals 16 may include multiple antennas to provide spatial diversity for communications. In some configurations, relay stations 15 may assist in communications between base stations 14 and wireless terminals 16. Wireless terminals 16 can be handed off 18 from any cell 12, sector 13, zone (not shown), base station 14 or relay 15 to an other cell 12, sector 13, zone (not shown), base station 14 or relay 15. In some configurations, base stations 14 communicate with each and with another network (such as a core network or the internet, both not shown) over a backhaul network 11. In some configurations, a base station controller 10 is not needed.

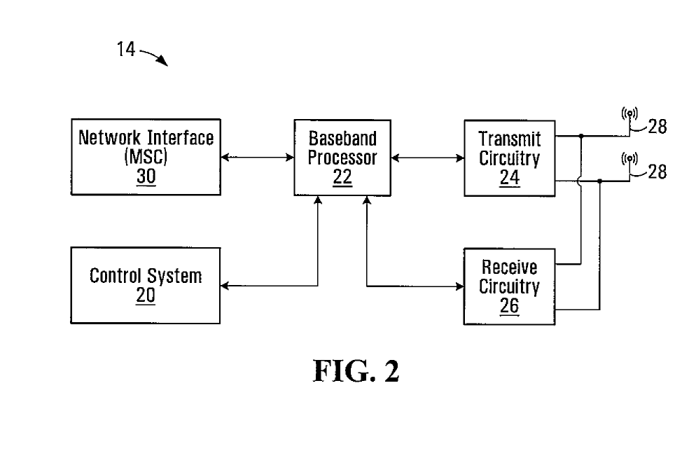

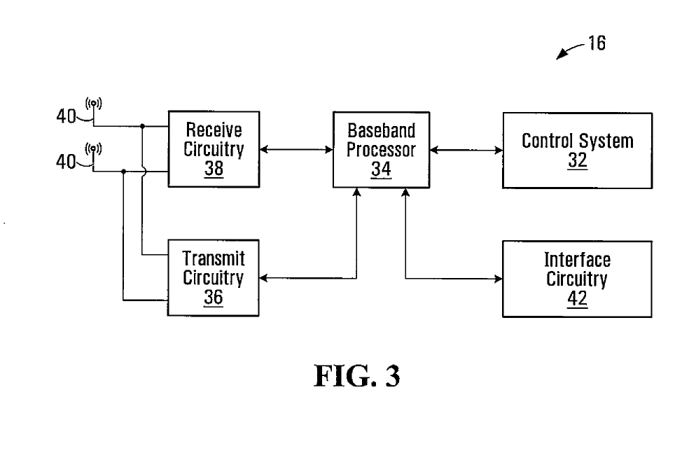

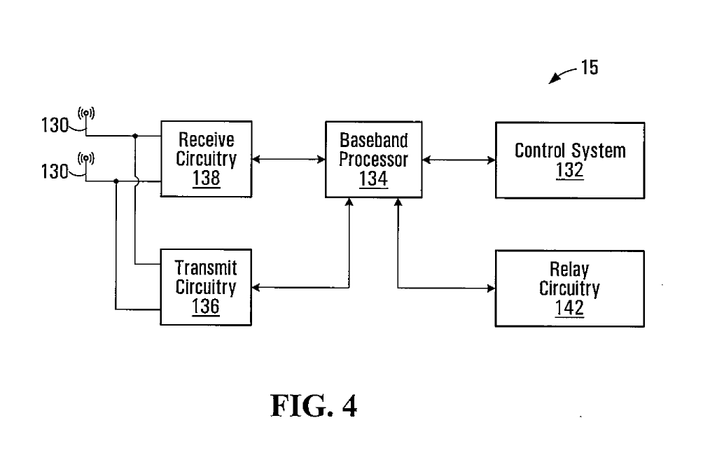

With reference to FIG. 2, an example of a base station 14 is illustrated. The base station 14 generally includes a control system 20, a baseband processor 22, transmit circuitry 24, receive circuitry 26, antennas 28, and a network interface 30. The receive circuitry 26 receives radio frequency signals bearing information from one or more remote transmitters provided by wireless terminals 16 (illustrated in FIG. 3) and relay stations 15 (illustrated in FIG. 4). A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 22 processes the digitized received signal to extract the information or data bits conveyed in the received signal. This processing typically comprises demodulation, decoding, and error correction operations. As such, the baseband processor 22 is generally implemented in one or more digital signal processors (DSPs) or application-specific integrated circuits (ASICs). The received information is then sent across a wireless network via the network interface 30 or transmitted to another wireless terminal 16 serviced by the base station 14, either directly or with the assistance of a relay 15.

On the transmit side, the baseband processor 22 receives digitized data, which may represent voice, data, or control information, from the network interface 30 under the control of control system 20, and encodes the data for transmission. The encoded data is output to the transmit circuitry 24, where it is modulated by one or more carrier signals having a desired transmit frequency or frequencies. A power amplifier (not shown) will amplify the modulated carrier signals to a level appropriate for transmission, and deliver the modulated carrier signals to the antennas 28 through a matching network (not shown). Modulation and processing details are described in greater detail below.

With reference to FIG. 3, an example of a wireless terminal 16 is illustrated. Similarly to the base station 14, the wireless terminal 16 will include a control system 32, a baseband processor 34, transmit circuitry 36, receive circuitry 38, antennas 40, and user interface circuitry 42. The receive circuitry 38 receives radio frequency signals bearing information from one or more base stations 14 and relays 15. A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 34 processes the digitized received signal to extract the information or data bits conveyed in the received signal. This processing typically comprises demodulation, decoding, and error correction operations. The baseband processor 34 is generally implemented in one or more digital signal processors (DSPs) and application specific integrated circuits (ASICs).

For transmission, the baseband processor 34 receives digitized data, which may represent voice, video, data, or control information, from the control system 32, which it encodes for transmission. The encoded data is output to the transmit circuitry 36, where it is used by a modulator to modulate one or more carrier signals that is at a desired transmit frequency or frequencies. A power amplifier (not shown) will amplify the modulated carrier signals to a level appropriate for transmission, and deliver the modulated carrier signal to the antennas 40 through a matching network (not shown). Various modulation and processing techniques available to those skilled in the art are used for signal transmission between the wireless terminal and the base station, either directly or via the relay station.

In OFDM modulation, the transmission band is divided into multiple, orthogonal carrier waves. Each carrier wave is modulated according to the digital data to be transmitted. Because OFDM divides the transmission band into multiple carriers, the bandwidth per carrier decreases and the modulation time per carrier increases. Since the multiple carriers are transmitted in parallel, the transmission rate for the digital data, or symbols, on any given carrier is lower than when a single carrier is used.

OFDM modulation utilizes the performance of an Inverse Fast Fourier Transform (IFFT) on the information to be transmitted. For demodulation, the performance of a Fast Fourier Transform (FFT) on the received signal recovers the transmitted information. In practice, the IFFT and FFT are provided by digital signal processing carrying out an Inverse Discrete Fourier Transform (IDFT) and Discrete Fourier Transform (DFT), respectively. Accordingly, the characterizing feature of OFDM modulation is that orthogonal carrier waves are generated for multiple bands within a transmission channel. The modulated signals are digital signals having a relatively low transmission rate and capable of staying within their respective bands. The individual carrier waves are not modulated directly by the digital signals. Instead, all carrier waves are modulated at once by IFFT processing.

In one embodiment, OFDM is preferably used for at least downlink transmission from the base stations 14 to the wireless terminals 16. Each base station 14 is equipped with “n” transmit antennas 28 (n>=1), and each wireless terminal 16 is equipped with “m” receive antennas 40 (m>=1). Notably, the respective antennas can be used for reception and transmission using appropriate duplexers or switches and are so labelled only for clarity.

When relay stations 15 are used, OFDM is preferably used for downlink transmission from the base stations 14 to the relays 15 and from relay stations 15 to the wireless terminals 16.

With reference to FIG. 4, an example of a relay station 15 is illustrated. Similarly to the base station 14, and the wireless terminal 16, the relay station 15 includes a control system 132, a baseband processor 134, transmit circuitry 136, receive circuitry 138, antennas 130, and relay circuitry 142. The relay circuitry 142 enables the relay 14 to assist in communications between a base station 16 and wireless terminals 16. The receive circuitry 138 receives radio frequency signals bearing information from one or more base stations 14 and wireless terminals 16. A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 134 processes the digitized received signal to extract the information or data bits conveyed in the received signal. This processing typically comprises demodulation, decoding, and error correction operations. The baseband processor 134 is generally implemented in one or more digital signal processors (DSPs) and application specific integrated circuits (ASICs).

For transmission, the baseband processor 134 receives digitized data, which may represent voice, video, data, or control information, from the control system 132, which it encodes for transmission. The encoded data is output to the transmit circuitry 136, where it is used by a modulator to modulate one or more carrier signals that is at a desired transmit frequency or frequencies. A power amplifier (not shown) will amplify the modulated carrier signals to a level appropriate for transmission, and deliver the modulated carrier signal to the antennas 130 through a matching network (not shown). Various modulation and processing techniques available to those skilled in the art are used for signal transmission between the wireless terminal and the base station, either directly or indirectly via a relay station, as described above.

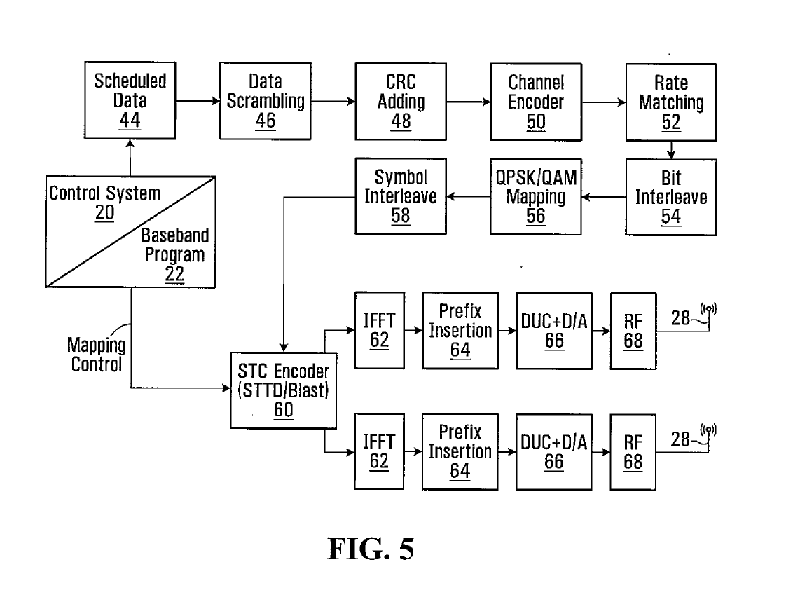

With reference to FIG. 5, a logical OEDM transmission architecture will be described. Initially, the base station controller 10 will send data to be transmitted to various wireless terminals 16 to the base station 14, either directly or with the assistance of a relay station 15. The base station 14 may use the channel quality indicators (CQIs) associated with the wireless terminals to schedule the data for transmission as well as select appropriate coding and modulation for transmitting the scheduled data. The CQIs may be directly from the wireless terminals 16 or determined at the base station 14 based on information provided by the wireless terminals 16. In either case, the CQI for each wireless terminal 16 is a function of the degree to which the channel amplitude (or response) varies across the OFDM frequency band.

Scheduled data 44, which is a stream of bits, is scrambled in a manner reducing the peak-to-average power ratio associated with the data using data scrambling logic 46. A cyclic redundancy check (CRC) for the scrambled data is determined and appended to the scrambled data using CRC adding logic 48. Next, channel coding is performed using channel encoder logic 50 to effectively add redundancy to the data to facilitate recovery and error correction at the wireless terminal 16. Again, the channel coding for a particular wireless terminal 16 is based on the CQI. In some implementations, the channel encoder logic 50 uses known Turbo encoding techniques. The encoded data is then processed by rate matching logic 52 to compensate for the data expansion associated with encoding.

Bit interleaver logic 54 systematically reorders the bits in the encoded data to minimize the loss of consecutive data bits. The resultant data bits are systematically mapped into corresponding symbols depending on the chosen baseband modulation by mapping logic 56. Preferably, Quadrature Amplitude Modulation (QAM) or Quadrature Phase Shift Key (QPSK) modulation is used. The degree of modulation is preferably chosen based on the CQI for the particular wireless terminal. The symbols may be systematically reordered to further bolster the immunity of the transmitted signal to periodic data loss caused by frequency selective fading using symbol interleaver logic 58.

At this point, groups of bits have been mapped into symbols representing locations in an amplitude and phase constellation. When spatial diversity is desired, blocks of symbols are then processed by space-time block code (STC) encoder logic 60, which modifies the symbols in a fashion making the transmitted signals more resistant to interference and more readily decoded at a wireless terminal 16. The STC encoder logic 60 will process the incoming symbols and provide “n” outputs corresponding to the number of transmit antennas 28 for the base station 14. The control system 20 and/or baseband processor 22 as described above with respect to FIG. 5 will provide a mapping control signal to control STC encoding. At this point, assume the symbols for the “n” outputs are representative of the data to be transmitted and capable of being recovered by the wireless terminal 16.

For the present example, assume the base station 14 has two antennas 28 (n=2) and the STC encoder logic 60 provides two output streams of symbols. Accordingly, each of the symbol streams output by the SIC encoder logic 60 is sent to a corresponding IFFT processor 62, illustrated separately for ease of understanding. Those skilled in the art will recognize that one or more processors may be used to provide such digital signal processing, alone or in combination with other processing described herein. The IFFT processors 62 will preferably operate on the respective symbols to provide an inverse Fourier Transform. The output of the TUFT processors 62 provides symbols in the time domain. The time domain symbols are grouped into frames, which are associated with a prefix by prefix insertion logic 64. Each of the resultant signals is up-converted in the digital domain to an intermediate frequency and converted to an analog signal via the corresponding digital up-conversion (DUG) and digital-to-analog (DIA) conversion circuitry 66. The resultant (analog) signals are then simultaneously modulated at the desired RF frequency, amplified, and transmitted via the RF circuitry 68 and antennas 28. Notably, pilot signals known by the intended wireless terminal 16 are scattered among the sub-carriers. The wireless terminal 16, which is discussed in detail below, will use the pilot signals for channel estimation.

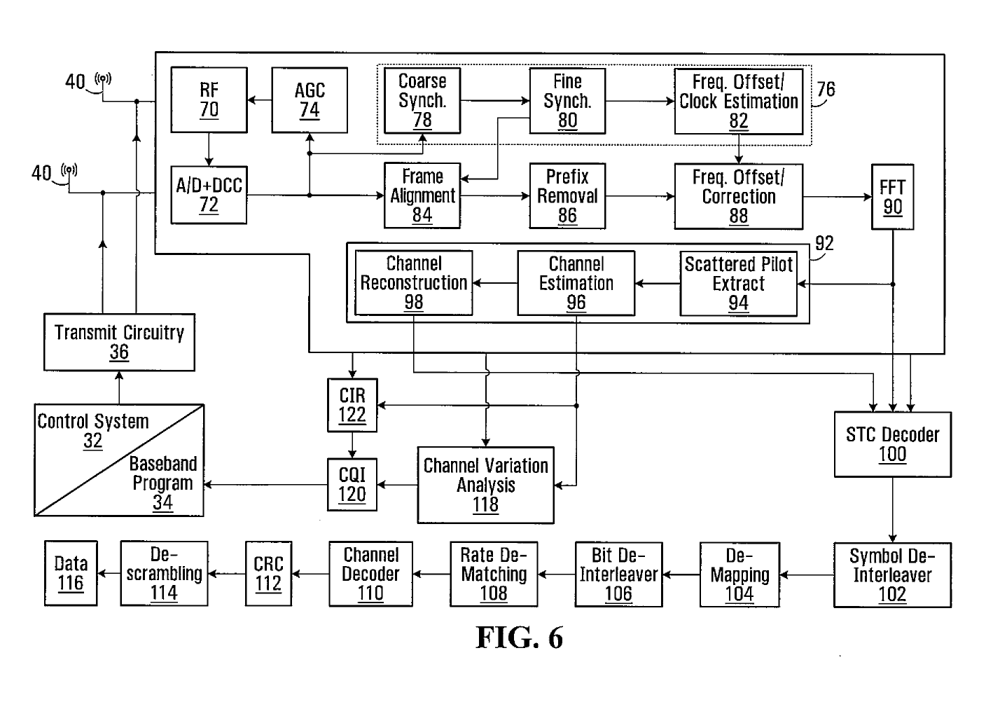

Reference is now made to FIG. 6 to illustrate reception of the transmitted signals by a wireless terminal 16, either directly from base station 14 or with the assistance of relay 15. Upon arrival of the transmitted signals at each of the antennas 40 of the wireless terminal 16, the respective signals are demodulated and amplified by corresponding RF circuitry 70. For the sake of conciseness and clarity, only one of the two receive paths is described and illustrated in detail. Analog-to-digital (AID) converter and down-conversion circuitry 72 digitizes and downconverts the analog signal for digital processing. The resultant digitized signal may be used by automatic gain control circuitry (AGC) 74 to control the gain of the amplifiers in the RF circuitry 70 based on the received signal level.

Initially, the digitized signal is provided to synchronization logic 76, which includes coarse synchronization logic 78, which buffers several OFDM symbols and calculates an auto-correlation between the two successive OFDM symbols. A resultant time index corresponding to the maximum of the correlation result determines a fine synchronization search window, which is used by fine synchronization logic 80 to determine a precise framing starting position based on the headers. The output of the fine synchronization logic 80 facilitates frame acquisition by frame alignment logic 84. Proper framing alignment is important so that subsequent PET processing provides an accurate conversion from the time domain to the frequency domain. The fine synchronization algorithm is based on the correlation between the received pilot signals carried by the headers and a local copy of the known pilot data. Once frame alignment acquisition occurs, the prefix of the OFDM symbol is removed with prefix removal logic 86 and resultant samples are sent to frequency offset correction logic 88, which compensates for the system frequency offset caused by the unmatched local oscillators in the transmitter and the receiver. Preferably, the synchronization logic 76 includes frequency offset and clock estimation logic 82, which is based on the headers to help estimate such effects on the transmitted signal and provide those estimations to the correction logic 88 to properly process OFDM symbols.

At this point, the OFDM symbols in the time domain are ready for conversion to the frequency domain using EFT processing logic 90. The results are frequency domain symbols, which are sent to processing logic 92. The processing logic 92 extracts the scattered pilot signal using scattered pilot extraction logic 94, determines a channel estimate based on the—extracted pilot signal using channel estimation logic 96, and provides channel responses for all sub-carriers using channel reconstruction logic 98. In order to determine a channel response for each of the sub-carriers, the pilot signal is essentially multiple pilot symbols that are scattered among the data symbols throughout the OFDM sub-carriers in a known pattern in both time and frequency. Continuing with FIG. 6, the processing logic compares the received pilot symbols with the pilot symbols that are expected in certain sub-carriers at certain times to determine a channel response for the sub-carriers in which pilot symbols were transmitted. The results are interpolated to estimate a channel response for most, if not all, of the remaining sub-carriers for which pilot symbols were not provided. The actual and interpolated channel responses are used to estimate an overall channel response, which includes the channel responses for most, if not all, of the sub-carriers in the OFDM channel.

The frequency domain symbols and channel reconstruction information, which are derived from the channel responses for each receive path are provided to an STC decoder 100, which provides STC decoding on both received paths to recover the transmitted symbols. The channel reconstruction information provides equalization information to the STC decoder 100 sufficient to remove the effects of the transmission channel when processing the respective frequency domain symbols.

The recovered symbols are placed back in order using symbol de-interleaver logic 102, which corresponds to the symbol interleaver logic 58 of the transmitter. The de-interleaved symbols are then demodulated or de-mapped to a corresponding bitstream using dc-mapping logic 104. The bits are then de-interleaved using bit de-interleaver logic 106, which corresponds to the bit interleaver logic 54 of the transmitter architecture. The dc-interleaved bits are then processed by rate dc-matching logic 108 and presented to channel decoder logic 110 to recover the initially scrambled data and the CRC checksum. Accordingly, CRC logic 112 removes the CRC checksum, checks the scrambled data in traditional fashion, and provides it to the de-scrambling logic 114 for de-scrambling using the known base station de-scrambling code to recover the originally transmitted data 116.

In parallel to recovering the data 116, a CQI, or at least information sufficient to create a CQI at the base station 14, is determined and transmitted to the base station 14 As noted above, the CQI may be a function of the carrier-to-interference ratio (CR), as well as the degree to which the channel response varies across the various sub-carriers in the OFDM frequency band. For this embodiment, the channel gain for each sub-carrier in the OFDM frequency band being used to transmit information is compared relative to one another to determine the degree to which the channel gain varies across the OFDM frequency band. Although numerous techniques are available to measure the degree of variation, one technique is to calculate the standard deviation of the channel gain for each sub-carrier throughout the OFDM frequency band being used to transmit data.

In some embodiments, a relay station may operate in a time division manner using only one radio, or alternatively include multiple radios.

FIGS. 1 to 6 provide one specific example of a communication system that could be used to implement embodiments of the application. It is to be understood that embodiments can be implemented with communications systems having architectures that are different than the specific example, but that operate in a manner consistent with the implementation of the embodiments as described herein.

With reference to FIG. 2, control system 20 of base station 14 may contain logic for executing methods exemplary of the present application. Similarly, with reference to FIG. 3, control system 32 of wireless terminals 16 may contain logic for executing methods exemplary of aspects of the present application.

As described in more detail below, base stations 14 are configured to signal active assignments to wireless terminals 16 by transmitting a terminal assignment index (TAI) to wireless stations 16. More specifically, base stations 14 classify wireless terminals 16 into groups according to a predefined metric. For example, wireless terminals 16 with roughly the same arrival time, and/or similar channel conditions, and/or same or similar MCS levels, may be grouped and identified by a Group ID. A particular wireless terminal 16 may belong to more than one group. A wireless terminal 16 may be added to, or removed from a group. Wireless terminals 16 within a group are ordered, such that a particular wireless terminal's assignments can be specified by a “1” for an active assignment in the appropriate position of a given ordered assignments bitmap for the group. An active assignment may be associated with one or more transmission resource units (e.g., frequency channel and/or time interval).

As previously noted, base station 14 signals ordered assignments to terminals within a group by transmitting a TAI to the group. The TAI is an index with a one-to-one relation to the set of possible ordered terminal assignments (active and inactive) for a given group size (i.e. total number of terminals in group) and a given number of active assignments in the group.

Ordered assignments indicate which terminals 16 are active (“1”) and which terminals 16 are inactive (“0”). As noted, a terminal 16 may be assigned a pre-determined position in an ordered group. This assignment may be indicated when the terminal 16 is joins the group. For example, for a group of four terminals 16, an ordered assignment of “1010” means the second and fourth terminals are inactive, and the first and third terminals of the group are active.

The TAI signal may be used in the allocation of an uplink resource for transmission by wireless terminal 16 to base station 14 or the allocation of a downlink resource for transmission by base station 14 to wireless terminal 16. Also, the TAI may be used for one or more (possibly all) transmissions/re-transmissions of a packet.

In operation, control system 20 of base station 14 may use TAI tables for different possible combinations of: (1) group size (i.e. total number of terminals in group), and (2) number of active assignments in the group. Each entry in a given TAI table contains a TAI number, a TAI field, and a corresponding ordered assignment. In some embodiments, the TAI tables can be replaced by a process or function to derive the TAI from ordered assignments given appropriate parameters.

Example TAI tables for the following four combinations are provided below: (1) group size of two terminals with two active assignments, (2) group size of three terminals with two active assignments, (3) group size of four terminals with two active assignments, and (4) group size of four terminals with one active assignment. In these examples, the number of resource units per user assignment is one.

It will be appreciated that other tables, formulas and/or relationships are possible, so long as given the TAI it is possible to derive the set of assignments for a group of terminals, and vice versa.

It is noted that in the following examples the “ordered assignments” column is equivalent the Ordered Assignments Bitmap (OAB) for the group in conventional systems.

For the case of a group of two terminals with two active assignments, there is only one case so that a single bit is needed for TAI indication. As only a single case exists, the other value of the bit may be used for indication of another feature or case (reserved).

TABLE 1
group of two terminals with two active assignments

| | | Ordered assignments |
|---|---|---|
| TAI number | TAI field | (conventional OAB) |
| | | 00 |
| | | 01 |
| | | 10 |
| 0 | 0 | 11 |
| 1 | 1 | Reserved |

For the case of a group of three terminals with two active assignments, there are three cases so that two bits are needed for TAI indication of all possible cases. The fourth value of the field may be used for indication of another feature or case (reserved).

TABLE 2
group of three terminals with two active assignments

| | | Ordered assignments |
|---|---|---|
| TAI number | TAI field | (conventional OAB) |
| | | 000 |
| | | 001 |
| | | 010 |
| 0 | 00 | 011 |
| | | 100 |
| 1 | 01 | 101 |
| 2 | 10 | 110 |
| | | 111 |
| 3 | 11 | Reserved |

For the case of a group of four terminals with two active assignments, there are six cases so that three bits are needed for TAI indication of all possible cases. The seventh and eighth values of the field may be used for indication of other features or cases (reserved 1 and 2).

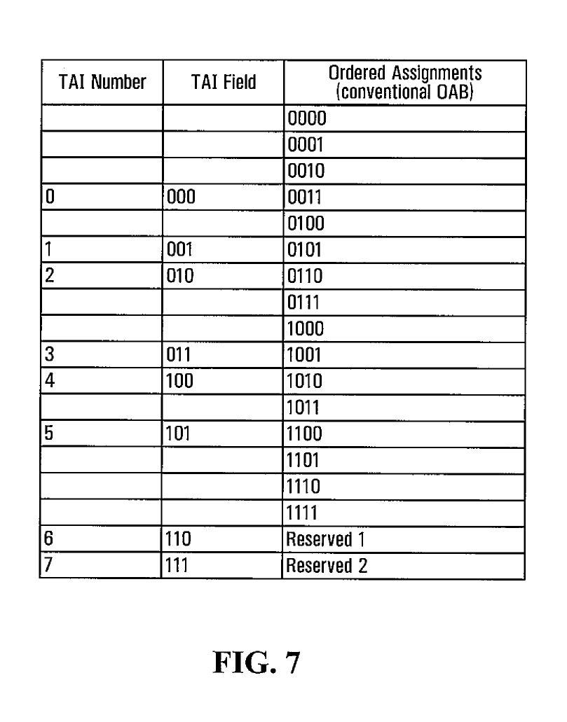

TABLE 3
group of four terminals with two active assignments (a copy of
which is reproduced as FIG. 7)

| | | Ordered assignments |
|---|---|---|
| TAI number | TAI field | (conventional OAB) |
| | | 0000 |
| | | 0001 |
| | | 0010 |
| 0 | 000 | 0011 |
| | | 0100 |
| 1 | 001 | 0101 |
| 2 | 010 | 0110 |
| | | 0111 |
| | | 1000 |
| 3 | 011 | 1001 |
| 4 | 100 | 1010 |
| | | 1011 |
| 5 | 101 | 1100 |
| | | 1101 |
| | | 1110 |
| | | 1111 |
| 6 | 110 | Reserved 1 |
| 7 | 111 | Reserved 2 |

For the case of a group of four terminals with one active assignment, there are four cases so that two bits are needed for TAI indication of all possible cases.

TABLE 4
group of four terminals with one active assignment

| | | Ordered assignments |
|---|---|---|
| TAI number | TAI field | (conventional OAB) |
| | | 0000 |
| 0 | 00 | 0001 |
| 1 | 01 | 0010 |
| | | 0011 |
| 2 | 10 | 0100 |
| | | 0101 |
| | | 0110 |
| | | 0111 |
| 3 | 11 | 1000 |
| | | 1001 |
| | | 1010 |
| | | 1011 |
| | | 1100 |
| | | 1101 |
| | | 1110 |
| | | 1111 |

During a given set of terminal assignments (active and inactive) for a group, base station 14 transmits to the terminals 16 within the group the TAI entry corresponding to the ordered assignments from the appropriate TAI table. As described in more detail below, terminals 16 know, or are able to determine, both the number of terminals in the group and the number of active assignments for the group. With knowledge of these two parameters, terminal 16 can determine the correct length in bits of the TAI field in order to detect and decode the TAI received from base station 14, as well as determine the appropriate TAI table to use to lookup the ordered assignments indicated by the received TAI. In some embodiments, the TAI tables can be replaced by a process or function to derive the ordered assignments from the TAI and the two known parameters (i.e. the number of terminals in the group and the number of active assignments for the group). If terminal 16 is assigned a position (ordered location) in the group, it can observe whether it has been given an active assignment (assigned resources), or set to inactive (not assigned resources) by checking its position in the ordered assignment.

In some embodiments, terminals 16 which are assigned to a group will know the number of terminals in the group. For example, base station 14 may indicate the number of terminals in a group by sending a control message to terminal 16 (e.g. DL_MAP in WiMAX). The message may contain an indication that terminal 16 is a member of a group identified by a Group ID, and it could contain an indication of the group size, the terminal's location in the group and the number of active assignments allowed for the group. With the group size and number of active assignments, terminal 16 can build the appropriate TAI table, such that when it receives a TAI from base station 14 it can derive the OAB and from the OAB determine which terminals in the group are active and, since it knows its location, it will know if it is one of the active terminals.

In some embodiments, rather than indicating the number of active assignments (A) to terminal 16, base station 14 may instead indicate the number of resource units assigned to the group (R), and the number of active assignments (A) can be derived by terminal 16 from the value R. That is, if the number of active resource units (R) and the number of resource units per active assignment (U) are known, the number of active assignments (A) may be derived by R by U (i.e. A=R/U). It is assumed that terminal 16 has knowledge of U (e.g., it is indicated by base station 14 or it is a standard value).

Advantageously, by transmitting a TAI instead of the OAB, the number of bits needed to signal active and inactive assignments to terminals 16 can be reduced. The TAI uses fewer bits than the conventional approach (i.e. OAB) as it assumes knowledge of the number of active assignments for the group. It is noted that knowledge of the group size is already assumed in the conventional approach, as terminals 16 need to know the correct length in bits of the OAB in order to detect and decode the OAB. As noted, the group size may be indicated by the base station 14 in a control region (e.g. DL_MAP in WiMAX), or it may be a standard size, for example.

A scenario will now be described wherein a terminal 16 uses knowledge of the group size, the number of assigned resource units (R), and the number of resource units per active assignment (U) to derive the number of active assignments (A), and thereby determine the appropriate TAI table to use. While the scenario describes use of TAI tables, it will be appreciated that an appropriate process or function may instead be used to derive TAIs from ordered assignments at base station 14, and similarly an appropriate process or function may be used to derive ordered assignments from TAIs at terminal 16. In the scenario, a group having a size of four terminals 16 is assigned two transmission resource units (R). The number of resource units per active assignment (U) is one. The first and fourth terminals 16 of the group are active (i.e. assigned resources). The conventional OAB for this scenario is “1001”. At base station 14, the ordered assignment “1001” is matched in the appropriate TAI table (Table 3, above) with corresponding TAI number “3” and TAI field “011”. The TAI of “011” (3 bits) is then transmitted to the terminals 16 in the group.

At terminal 16, the terminal has knowledge that the group is assigned two transmission resource units (R=2) and that the number of resource units per active assignment is one (U=1). Hence, terminal 16 is able to determine that there are two active assignments (A) in the group (A=R/U). The size of the group is also already known by terminal 16, and in this case it is four. Terminal 16 therefore is able to determine the correct length (3 bits) of the TAI field in order to detect and decode the RAI field received from base station 14, as well as determine the appropriate TAI table (Table 3, above) to use to lookup the ordered assignments indicated by the received TAI. Thus, upon decoding the TAI field of “011”, terminal 16 derives the ordered assignments bitmap of “1001” by performing a lookup in the appropriate TAI table. Terminal 16 is then able to determine its resource assignment based on its assigned position in the group.

While embodiments have been described in which the number of resource units per active assignment is a predefined number (U), it is to be understood that embodiments can be implemented where the number of resource units per active assignment may be dynamically assigned in manners known in the art. For example, in addition to transmitting the TAI to terminals 16, base station 14 may also transmit a resource allocation bitmap (RAB) to indicate the amount of transmission resources being allocated to each active terminal in the group. For example, the first bit of the RAB may correspond to the first active terminal, the second bit of the RAB may correspond to the second active terminal, the third bit of the RAB may correspond to the third active terminal, and so on. A “1” in the RAB may indicate that X units of the transmission resource will be assigned while a “0” may indicate that Y units of the transmission resource will be assigned, where for example X is greater than Y. It will be appreciated that other conventional methods of dynamically assigning varying amounts of transmission resources for each active assignment in a group of terminals 16 may be used.

As previously noted, the TAI field can be used to efficiently signal some or all transmissions of a packet transmission. In some embodiments, the TAI field can signal HARQ re-transmissions for a group of terminals 16, where the group of terminals 16 has a persistent assigned first HARQ transmission opportunity. Specifically, as the first HARQ transmission is persistently assigned, signalling is not needed for this transmission. A resource availability bitmap may be used to indicate to other terminal/groups which resources are “in use”. For re-transmissions, the terminals who have been allocated resources for a HARQ re-transmission of packet are indicated by the TAI. As the number of terminals in a group who require re-transmission may be small in some cases, there is potential savings in overhead in comparison to signalling the ordered bitmap of assignments explicitly. Further, it can be advantageous to configure the group of terminals such that each terminal in the group has its first transmission opportunity in the same sub-frame (or frame, or scheduling event).

For example, consider a group having a size of four terminals. All four terminals are allocated predefined or persistent resources, for their first HARQ transmission. At a specific scheduling interval, all four terminals have a first HARQ packet transmission which is sent on persistent resources. The group is not signalling in this scheduling interval. At a later time the group is scheduled for a first re-transmission opportunity. The packet for terminal 2 has need of a second transmission, whereas the packets for terminals 1, 3, and 4 have been received successfully and do not require re-transmission. The ordered assignments can be expressed as “0100”, and an appropriate TAI can be sent to indicate the assignments. Using the example table 4, above, the TAI “10” can be sent to represent the active/inactive assignments for the terminals of the group. This process can be repeated for further re-transmissions.

Other modifications will be apparent to those skilled in the art and, therefore, the invention is defined in the claims.

What is claimed is:

1. A method of signalling active assignments to an ordered group of wireless terminals in communication with a base station in a wireless communication system, each wireless terminal of said ordered group having a corresponding position within said ordered group, said method comprising:
at said base station:
determining an allocation of active assignments for said ordered group, said allocation corresponding to a number of active assignments;
determining an index value identifying said allocation in a set of possible allocations for said number of active assignments for said ordered group; and
transmitting said index value to at least one wireless terminal of said ordered group of wireless terminals.

2. The method of claim 1, further comprising transmitting an indication of the size of said ordered group to said at least one wireless terminal.

3. The method of claim 2, further comprising transmitting to each of said at least one wireless terminal an indication of its corresponding position within said ordered group.

4. The method of claim 1, further comprising:
assigning each wireless terminal in said ordered group a position within a bitmap, said position within said bitmap corresponding to said position within said ordered group, wherein a bit set to “1” in said bitmap indicates an active assignment and a bit set to “0” in said bitmap indicates an inactive assignment, such that said bitmap indicates said allocation;
creating a table associating an index with a corresponding set of values for said bitmap, said set of values corresponding to said set of possible allocations of said number of active assignments for said ordered group; and
wherein said determining said index value comprises using said table to identify said index value in said index using said bitmap.

5. The method of claim 1, wherein said active assignments indicate which of said wireless terminals have been allocated transmission resources, and wherein said method further comprises allocating a number of transmission resource units to each of said active assignments.

6. The method of claim 1, wherein said active assignments indicate which of said wireless terminals have been allocated resources for re-transmission of a packet, and wherein said method further comprises allocating a number of transmission resource units to each of said active assignments.

7. The method of claim 6, wherein said re-transmission is a HARQ re-transmission.

8. The method of claim 1, further comprising transmitting an indication of said number of active assignments to said at least one wireless terminal.

9. The method of claim 5, further comprising transmitting an indication of a number of active resource units and a number of resource units per active assignment to said at least one wireless terminal.

10. A base station forming part of a communication system, said base station in communication with an ordered group of wireless terminals, each wireless terminal of said ordered group having a corresponding position within said ordered group, said base station comprising logic operable to:
determine an allocation of active assignments for said ordered group, said allocation corresponding to a number of active assignments;
determine an index value identifying said allocation in a set of possible allocations for said number of active assignments for said ordered group; and
transmit said index value to at least one wireless terminal of said ordered group of wireless terminals.

11. The base station of claim 10, wherein said logic is further operable to transmit an indication of the size of said ordered group to said at least one terminal.

12. The base station of claim 11, wherein said logic is further operable to transmit to each of said at least one wireless terminal an indication of its corresponding position within said ordered group.

13. The base station of claim 10, wherein said logic is further operable to:
assign each wireless terminal in said ordered group a position within a bitmap, said position within said bitmap corresponding to said position within said ordered group, wherein a bit set to “1” in said bitmap indicates an active assignment and a bit set to “0” in said bitmap indicates an inactive assignment, such that said bitmap indicates said allocation;
create a table associating an index with a corresponding set of values for said bitmap, said set of values corresponding to said set of possible allocations of said number of active assignments for said ordered group; and
wherein said determining said index value comprises using said table to identify said index value in said index using said bitmap.

14. The base station of claim 10, wherein said active assignments indicate which of said wireless terminals have been allocated transmission resources, and wherein said logic is further operable to allocate a number of transmission resource units to each of said active assignments.

15. The base station of claim 10, wherein said active assignments indicate which of said wireless terminals have been allocated resources for re-transmission of a packet, and wherein said logic is further operable to allocate a number of transmission resource units to each of said active assignments.

16. The base station of claim 15, wherein said re-transmission is a HARQ re-transmission.

17. The base station of claim 10, wherein said logic is further operable to transmit an indication of said number of active assignments to said at least one wireless terminal.

18. The base station of claim 14, wherein said logic is further operable to transmit an indication of a number of active resource units and a number of resource units per active assignment to said at least one wireless terminal.

19. A wireless terminal comprising logic operable to:
receive from a base station an indication that said wireless terminal has been added to an ordered group of wireless terminals;
receive from said base station a terminal assignment index (TAI); and
use said TAI to derive an ordered assignment bitmap (OAB), where each wireless terminal in said ordered group is associated with a respective bit position of said OAB.

20. The wireless terminal of claim 19, wherein said logic is further operable to receive from said base station an indication of the size of said ordered group.

21. The wireless terminal of claim 20, wherein said logic is further operable to determine a number of active assignments for said ordered group.

22. The wireless terminal of claim 21, wherein said using said TAI to derive said OAB comprises:
building a TAI table given said size of said ordered group and said number of active assignments for said ordered group; and
using said TAI to lookup said OAB in said TAI table.

23. The wireless terminal of claim 21, wherein said determining said number of active assignments comprises receiving from said base station an indication of said number of active assignments.

24. The wireless terminal of claim 21, wherein said determining said number of active assignments comprises:
receiving from said base station an indication of a number of assigned resource units for said ordered group;
receiving from said base station an indication of a number of resource units per active assignment; and
dividing said number of assigned resource units by said number of resource units per active assignment.

25. The wireless terminal of claim 20, wherein said logic is further operable to receive from said base station an indication of a location for said wireless terminal within said ordered group.
